(19) United States
(12) Patent Application Publication
(10) Pub. No.: US 2013/0142381 A1
(43) Pub. Date: Jun. 6, 2013

(54) REAL TIME SPECTROSCOPY PROCESSING AND ANALYSIS SYSTEM

(71) Applicant: Thomas Richard Field, Seattle, WA (US)

(72) Inventor: Thomas Richard Field, Seattle, WA (US)

(73) Assignee: FIELD TESTED SOFTWARE LLC, Seattle, WA (US)

(21) Appl. No.: 13/310,185

(22) Filed: Dec. 2, 2011

(51) Int. Cl. G06K 9/00

(52) U.S. Cl. 382/100

(57) ABSTRACT

A real time spectroscopy processing and analysis system comprising a data acquisition module, an image processing module operably connected to the data acquisition module and a data analysis and presentation module operably connected to both the data acquisition module and the image processing module.

### FIELD OF THE INVENTION

The present invention relates to spectroscopy processing and analysis systems and more specifically to a real time spectroscopy processing and analysis system that is simple, integrated and efficient.

### BACKGROUND

Astronomers and other scientists convert light from stars and other samples, like planets, or flame spectroscopy, or chemical spectroscopy, two spectra with many different devices, such as a prism, a diffraction grating, or spectroscope. The spectra can be recorded on a camera in either color or black-and-white. When the spectra are examined closely, they will have gaps and different color intensities. The position, shape, and depth of those gaps can be measured to reveal many physical properties of the sample objects that generated the light or through which the light passed. For example, the chemical composition of stars can be determined using the gaps in the spectra obtained like a chemical fingerprint. The shape of a spectrum can be used to determine the temperature of the sample. However, studying spectra is a difficult and qualitative task, so scientists convert spectra to graphs called profile graphs.

There are many spectrographical processing and analysis systems currently available, such as, for example, VSpec, IRIS, ISIS and CCDOPS. However, using the existing systems to convert spectra to profile graphs has been cumbersome, requiring many steps and frequently different software programs to convert the image to a final graph. Using current technology, researchers have to collect image, then go through multiple steps, and even multiple programs and systems, in order to achieve usable results. Additionally, none of the currently available programs or systems can generate profile graphs in real time. With the currently available systems, researchers have to wait for long periods of time to see if any usable results have been obtained. This is highly inefficient and time-consuming.

Therefore, there is a need for a real time spectroscopy processing and analysis system that is simple, integrated and efficient.

### SUMMARY

What is presented is a real time spectroscopy processing and analysis system comprising computer instructions for a data acquisition module, an image processing module and a data analysis and presentation module. The data acquisition module comprises instructions to acquire and convert a plurality of image and video formats into a single, two dimensional (2D), intensity frame buffer data format. The image format conversion includes converting FITS file images, conventional images, video recordings, and live video into the single data format. The conventional images can be TPG, BMP, TIF and DSLR raw. Optionally, the data acquisition module can automatically enter and convert the images to the single data format by monitoring a specific file location or one or more file folders. Live video data can optionally be tracked using a log file. Additionally, the live video data is reduced in size by dropping frames and can be cropped prior to being converted. A user can also manually cut-and-pasted an image into the system for processing. The image is displayed to the user. After the images have been acquired and converted, a notification trigger is transmitted to the image processing module and the data analysis and presentation module.

The image processing module receives frame buffer data from the data acquisition model. The RGB color intensity of the frame buffer data is changed into monochrome intensities that are rotated and tilted. Binning lines are overlaid onto the rotated and tilted monochrome frame buffer data and an intensity histogram of the data is displayed in a zoomable preview window. In another embodiment, a background is subtracted from the monochrome rotated and tilted frame buffer data. The data is then vertically and horizontally binned. The image processing module transmits a notification signal indicating that binned pixels data is available for processing.

The binned pixels data is received by the data analysis and presentation module, where the digital tracking of the binned data is processed. The digital tracking of the binned data is processed using a frame averaging, and the quality of the frame is calculated and determined. If the calculated quality falls below a threshold, the frame is discarded. The remaining frames have pixels converted to angstroms using calibration factors provided by a user, these factors include linear, non-linear and polynomial factors. The angstrom calibration data is synthesized into either a color or monochrome spectrum and displayed. The binned pixels data is adjusted for instrument response and plotted and an overlay of the processed data is displayed. The overlay comprises sections from the element library, a reference graph and labels.

In another embodiment, a Barycenter calculation, a full width half maximum calculation or both a Barycenter and a full width half maximum calculation is performed on the binned data and a plot of the calculation is displayed. The full width half maximum calculations can be a Gaussian calculation or a geometric calculation. A text of the calculation results is displayed to the user.

In another embodiment, a running graph of focus quality determined by a calculated full width half maximum value, a feature depth or both a calculated full width half maximum value and a feature depth is also displayed.

In one embodiment there is provided some steps of a method for real time spectroscopy processing and analysis comprising computer instructions for: a) acquiring image data; b) processing the image data; c) analyzing the image data analysis; and d) presenting the image data. The step of acquiring the data further comprises the step of acquiring and converting a plurality of image and video formats into a single data format, where the formats can be conventional images, video recordings, and live video. Optionally, the images can be automatically acquired and converted by monitoring a specific file location or one or more file folders. The image from the camera is displayed along with binning lines to isolate the data contained in the image.

The live video data is reduced in size by dropping frames and cropped prior to being converted. The image data is converted into a two dimensional intensity frame buffer where the RGB color intensities of the frame buffer data is converted into monochrome intensities. The monochrome frame buffer data is rotated and tilted and binning lines are overlaid on the data. An intensity histogram of the data is then displayed in a zoom/preview window. Optionally, a background is subtracted from the monochrome rotated and tilted frame buffer data. The image data is then vertically and horizontally binned.

The data is then processed using a frame averaging. The quality of the frame average is then calculated and if the quality falls below a threshold the frame is discarded. Next, a pixel is converted to angstroms using calibration factors provided by the user, where the factors provided by the user can be linear, non-linear and polynomial. The angstrom calibration data synthesized into a color or a monochrome spectrum and displayed. Adjustments for instrument response of the binned data is then calculated and plotted on the display. Additionally, sections from the element library, a reference graph and one or more than one label are overlaid and displayed along with the processed data.

A Barycenter, a full width half maximum or both a Barycenter and a full width half maximum are calculated using the binned data. T full width half maximum calculations can be a Gaussian calculation, a geometric calculation or both a Gaussian and a geometric calculation. Text of this calculation is displayed to the user along with a graphical overlay of the full width half maximum plot. A running graph of focus quality determined by a calculated full width half maximum value, a feature depth or both a calculated full width half maximum value and a feature depth is also displayed.

### BRIEF DESCRIPTION OF THE DRAWINGS

These and other features, aspects and advantages of the present invention will become better understood with regard to the following description, appended claims, and accompanying figures where:

FIG. 1 is a diagram of a real time spectroscopy processing and analysis system that is simple, integrated and efficient according to one embodiment;

FIG. 2 is a is a flowchart diagram of a data acquisition module useful in the system of FIG. 1;

FIG. 3 is a flowchart diagram of an image processing module useful in the system of FIG. 1;

FIG. 4 is a flowchart diagram of a data analysis and presentation module useful in the system of FIG. 1;

FIG. 5 is a screenshot of a real time spectroscopy processing and analysis system that is simple, integrated and efficient according to one embodiment;

FIG. 6 is a screenshot of a geometric data calculation for determining the full width half maximum of the data according to one embodiment;

FIG. 7 is a screenshot of a synthesized spectrum;

FIG. 8 is an exemplary image illustrating image tilt shifted in the x-axis caused by a moving object or a hardware configuration;

FIG. 9 is a screenshot of user selected binning lines for a range of spectroscopic data to be processed;

FIG. 10 is an exemplary graph of a full width half maximum calculation according to one embodiment; and

FIG. 11 is a screenshot of a graphical user interface according to one embodiment of the invention.

### DETAILED DESCRIPTION

The present invention overcomes the limitations of the prior art by providing a real time spectroscopy processing and analysis system that is simple, integrated and efficient according to one embodiment. The present invention combines all the steps required to produce a profile graph from spectra, into a single integrated system that can perform the process on one or more images presented in real-time with no additional actions required by the operator. The input images can be still pictures or video.

The present invention is a complete integrated interactive data reduction pipeline. Each image that is loaded comprises all of the image processing, data analysis and presentation primers applied automatically. The system is fully “threaded” which means that all calculations are separate, isolated processes, internal to the system. The user can have multiple windows visible, that information can be input level software continues to process a video image or image stream in real time, applying the user designated transformations, adjustments, extractions, combinations, manipulations, or displaying the results. This concurrent operation makes system operate in an easy, intuitive manner for the user. Additionally, the user can make adjustments “on-the-fly” and see the results immediately.

The system and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known coding patterns, structures and techniques may not be shown in detail in order not to obscure the embodiments. For example, code may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, concurrently, in parallel or by distributed means, such as, for example, grid computers or distributed computers. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “module(s)” or “component(s)” refers to computer instructions operable on a processor to perform a specific task.

The term “binning” or “binned” refers to combining a cluster of pixels from and image into a single pixel, such as, in binning, an array of 4 pixels becomes a single larger pixel, reducing the overall number of pixels and reducing the impact of noise on the processed image.

Various embodiments provide a real time spectroscopy processing and analysis system and methods that are simple, integrated and efficient. One embodiment of the present invention provides a system comprising instructions operable on a computer for performing tasks of data acquisition, image processing, and data analysis and presentation. In another embodiment of the present invention, a method for using the system is presented. The system and method will now be disclosed in detail.

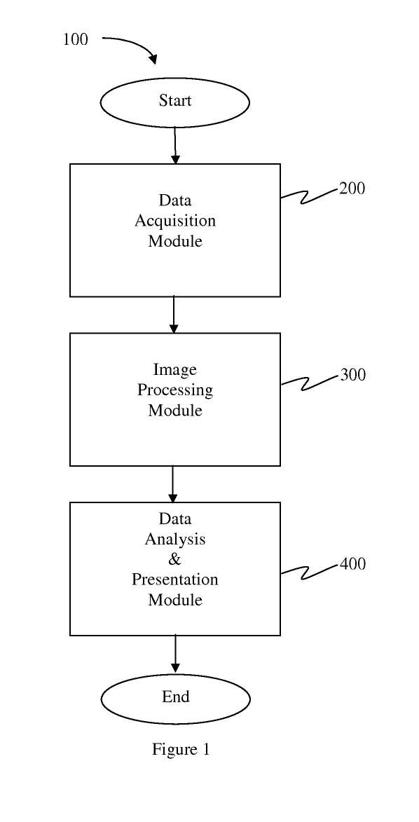

Referring now to FIG. 1, there is shown a diagram 100 of a real time spectroscopy processing and analysis system that is simple, integrated and efficient. As can be seen, the system 100 comprises three basic modules: a) a data acquisition module 200; be) an image processing module 300; and c) a data analysis and presentation module 400.

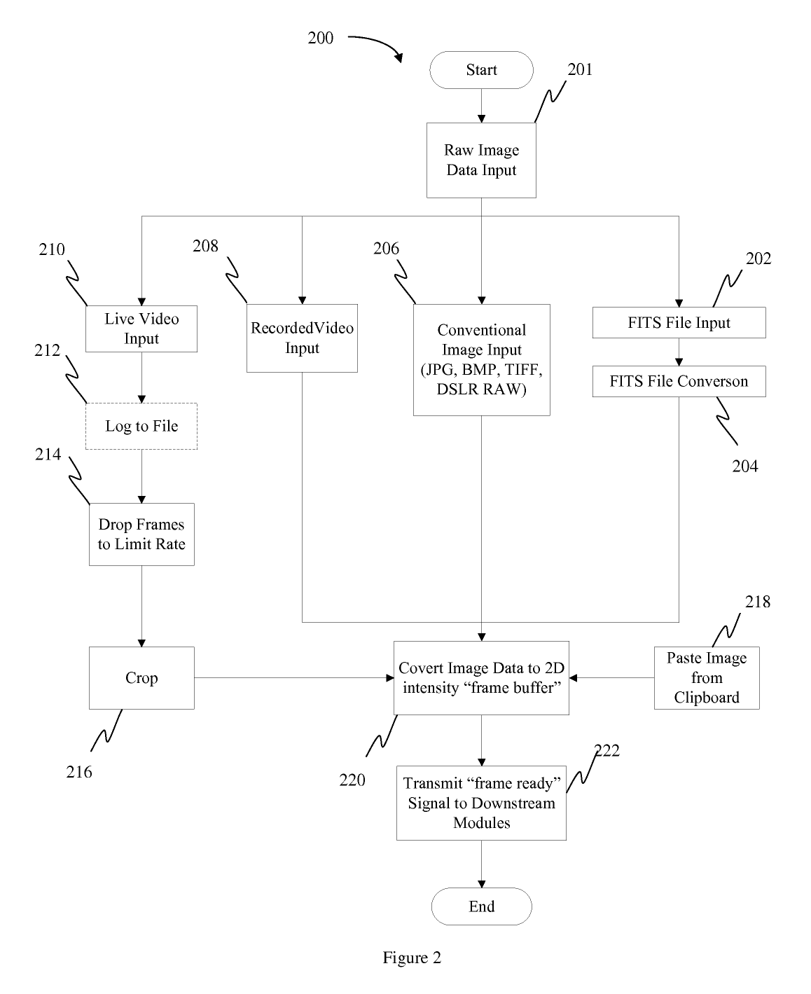

FIG. 2 is a flowchart diagram of a data acquisition module useful in the system of FIG. 1. The data acquisition module 200 comprises instructions to the system for acquiring and converting various image and video formats into a usable format for the other modules of the system. For example, the data acquisition module 200 comprises instructions for a processor that are operable to acquire a FITS file 202 and perform the requisite file conversion 204 for continued processing. The data acquisition module 200 also comprises instructions for converting conventional images 206, video recordings 208, and live video 210 into usable data for the system 100. The conventional images 206 can be selected from the group consisting of TPG, BMP, TIF, DSLR raw, and other common file formats known to those with skill in the art with reference to this disclosure. Optionally, the data acquisition module 200 can comprise instructions so that these various common file formats and FITS files can be automatically entered and converted into the system by monitoring specific file locations or folders, eliminating the need for user interaction.

Each module is a self-contained, threaded object that generates and responds to specific events. Using events, components can be connected together in a stream were data frames are passed from one to the next to the next. Data (images and profile graphs) and execution pass from one module to the next. The system is built on a distributed, multi-core threading framework with full interlocking. Each module comprises a lightweight thread so each module can operate independently, using multiple-cores if available and concurrently processing if available.

In one embodiment, when a user makes a change in image processing, the system 100 can trigger the entire data processing stream 200, 300 and 400 to apply all of the processing steps to the data again. This means that the user does not have to re-apply the all the steps, one at time and that all processing steps downstream from the trigger point are re-applied to the frame data with no additional user input.

Live video 210 data can optionally be saved to storage using a log file 212. The amount of data to be processed from the live video 210 data will be reduced by instructions in the data acquisition model 200 by dropping frame rates 214. Additionally, the live video 210 data is cropped prior to being converted 220 into useful data for the rest of the system.

Alternatively, the user can cut-and-paste images a recognizable data files in the system using the available clipboard paste functions 218.

Once the data acquisition module 200 has located the images to be converted, the images are converted 220 into two dimensional (2D), intensity frame buffer data 222. Once the data acquisition module 200 has finished converting the data, a trigger 222 is transmitted to the image processing module 300 and the data analysis and presentation module 400.

The frame data acquired by the data acquisition module 200 can be represented in the following data structure:

DataFrameType = object

Public Function GetFramePixel( Row, Col: Word): Integer // returns

the pixel value of a specific cell

Public Function GetFrame Width: Word // width of frame
Public Function GetFrameHeight: Word
Public Procedure SetFramePixel( Row, Col, Value: Integer)

End

A real-time video stream can be defined using a generic abstract object that provides an interface for communicating with a camera as a data source for the data acquisition module 200.

Specific cameras are implemented as a descendent, polymorphic object of this abstract object. The higher level code that communicates with cameras instantiates a specific instance of the camera descendent object, depending on the specific camera type in use. All subsequent camera code (start-buttons, etc.) communicates through the common interface defined by the abstract camera object, and is independent of the camera used. The low level video object generates an event (or callback) whenever a frame is available from the camera. Higher level code catches the event and processes the video frame (2D matrix).

In one embodiment a base class defines common camera operations in the interface below and descendent objects implement the functionality.

Property Paused: Boolean
Property LoggingFileName: string
Property Framerate: Word:
Property 32BitData: Boolean // false if byte-size pixels
Procedure StartCameraCapture abstract
Procedure StopCameraCapture abstract
Function StartLoggingToFile( aLoggingFileName: String
out aErrm: String):boolean abstract
Function StopLoggingToFile(out aErrm: String):boolean abstract
Procedure PauseLoggingToFile abstract
Function ResumeLoggingToFile( out Errm: String):boolean abstract
function UserChooseCamera( ParentForm: TForm):boolean abstract
Procedure AdjustCamera( ParentForm: TForm) abstract
Function GetAvailableVideoDialogs: TCaptureDialogs abstract
Procedure ShowVideoDialog( aVideoDialog: DialogType
aPauseVideo: Boolean) virtual abstract // camera selection and
controls (contrast, etc.)
Public Property Read/Write FrameObject: DataFrameObject // owner

can access the contents of the frame through this.

procedure Crop( aCropOn: Boolean
aImageBufferHeight: Integer
aRowStart: Integer
aRowStop: Integer) virtual abstract

This object class also has a public function to turn on simultaneous logging of the video file to disk while generating frames.

If the video source is standard computer video (byte-sized pixels) the variable 32 BitData is set false. This allows internal and external processing to be done on bytes rather than words, speeding up processing. Additionally, dynamic pixel sizing where the system 100 adapts to the size of incoming data can be used.

Client code using the camera object can also call a function in the camera object's interface that turns cropping on and off. This pre-cropping of the image at the earliest possible moment is effective in improving data frame rates, since in spectroscopy only a small horizontal sliver of the rows in a typical image have data. If the camera provides cropping, the code can use that.

A cropping object receives frames and returns the cropped image. This cropping object can implement the cropping via hardware or the cropping can be done in the data acquisition module 200. Below is an algorithm for cropping in one embodiment of the data acquisition module 200.

Software row cropping:
OutputRow = 0
For InputRow = 0 to FramesMaximumRow

if (InputRow >= CropRegionTopRow) AND (InputRow <=
CropRegionBottomRow)
{ OutputRow = OutputRow + 1
TransferRowToOutputFrame(InputRow, OutputRow)

The data acquisition module 200 can control the frame rate using the camera object to specify a maximum frame rate. Additionally, the data acquisition module 200 communicates the requested frame rate to the camera hardware (if the camera has a variable frame rate). The camera object can also make use of a software frame rate controller object, applying a user-defined frame maximum, discarding frames that come faster than that rate:

Function FrameRateIsTooFast:Boolean

FrameRatelsTooFast = (CurrentTime − PreviousFramesTime) <

MinimumGapBetweenFrames
End

Limiting the frame rate can significantly improves the responsiveness of the system 100 and provides ability to handle fast data streams. In spectroscopy, we're imaging a point source (star or slitted image) so a high speed frame rate currently used by planetary observers use isn't necessary.

Output from the video object, as noted above, is an event that signals that the frame is ready. The frame may already be cropped. The rate of events generated by this object may be lower than the camera is sending frames (because the object is discarding frames to keep the frame rate below a user-requested maximum)

The playback of a recorded video file can also be used as input into the data acquisition module 200. This object is very similar to the live video stream, generating events (or callbacks) for each frame.

Property Paused: Boolean
Property Framerate: Word:
Property CurrentFrameNumber: read/write Word
function RegisterCallback( CallbackProcedure: Procedure) // The object's owner

registers a procedure to be called when a frame is ready. This object generates a “Frame
Ready” event by calling the CallBackProcedure.

Public Property Read/Write FrameObject: DataFrameObject // owner can access the

contents of the frame through this.

procedure Crop( aCropOn: Boolean
aImageBufferHeight: Integer
aRowStart: Integer
aRowStop: Integer) virtual abstract

Still Images Video:
A generic object ImageObject generates a frame that it reads from a static image (jpg,
bmp, jpg, FITS).
This object hides all of the complexities of different formats, making available the
image's pixels regardless of their source.
ImageObject = Object

Function OpenImage( FileName: String):Boolean
Public Function GetFramePixel( Row, Col: Word): Integer // returns the pixel value of a

specific cell

Public Function GetFrame Width: Word // width of frame
Public Function GetFrameHeight: Word

function RegisterCallback( CallbackProcedure: Procedure) // The object's owner

registers a procedure to be called when a frame is ready. This object generates a “Frame Ready”
event by calling the CallBackProcedure that can be helpful if downstream changes are made and
the higher order imaging processing components instructs the changes to be applied to the
current image.

Procedure Pump // owner can cause this to cause the object to signal the most recent

frame should be resent, which the object does by calling the Callbackprocedure.

End

The data acquisition module 200 can monitor a user-selected folder to automatically input images. If a new image file appears, it is automatically loaded and an event/callback is generated to notify the system 100 of the event. This automatic notification can be implemented by using the operating system API to generate an event whenever a new file appears in one embodiment. This can be quite difficult and fragile to implement, because some OSes (Windows) don't easily generate a callback when a file is actually closed, just when it is appended or opened and the system 100 uses the file close event to operate in this embodiment.

In a preferred embodiment an internal timer with one-second interval is created. A list of all the file names already in the folder is created. When an event occurs, the created list is compared to a newly generate list as shown in the pseudo code below:

For Each FileName in Folder do
If FileName is an image file (*.FIT, *.JPG, etc) and (NOT File in
FilesSeenList)

AND FileIsClosed AND File's TimeStamp is more recent than the current
ReturnFileName then

ReturnFileName = FileName

ReturnFileTimeStamp = FilesName's TimeStamp
End
Function to test if file is closed:
Function FileIsCurrentlyClosed( aFileName: String):Boolean
variable

hInputFile: Handle
hInputFile = CreateFile( aFilename, GENERIC_WRITE, 0, nil,

OPEN_EXISTING, FILE_ATTRIBUTE_NORMAL, 0)

Return( (hInputFile <> INVALID_HANDLE_VALUE))
if Result then
CloseHandle(hInputFile)

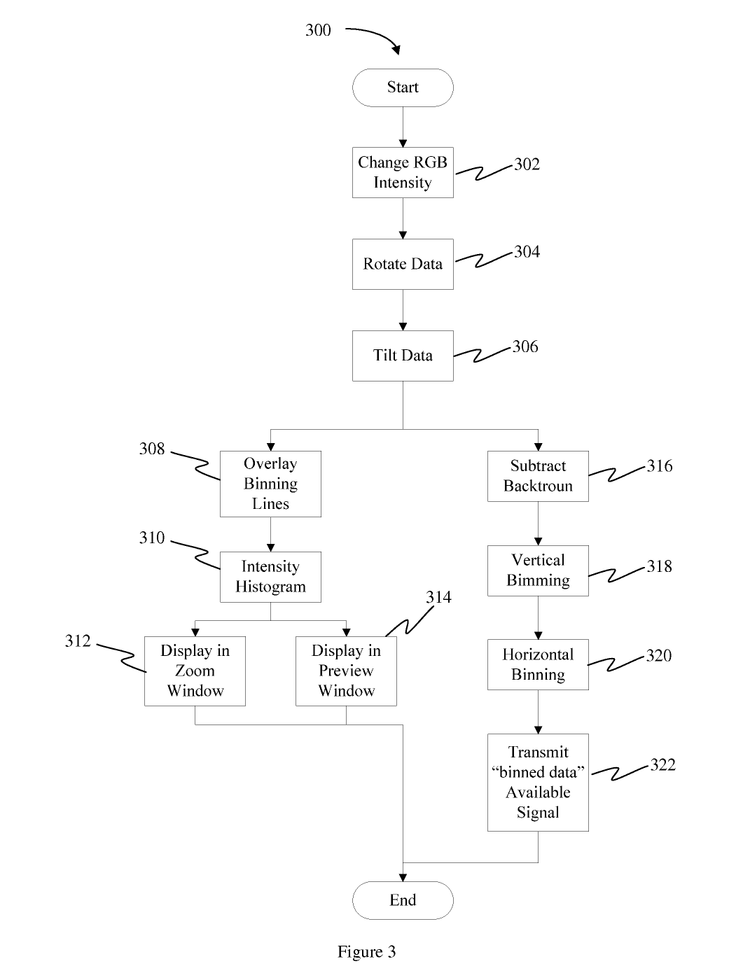

FIG. 3 is a flowchart diagram of an image processing module 300 useful in the system of FIG. 1. The image processing module 300 receives frame buffer data 222 from the data acquisition model 200. The image processing module 300 comprises instructions for the processor to change RGB color intensity 302 of the frame buffer data 222 into monochrome intensities from the received frame buffer data 222224. The monochrome frame buffer data 222 is then rotated 304 for further processing. The image processing module 300 then tilts the rotated monochrome frame buffer data 222. At this point, depending upon user input, the image processing module 300 will take one of two actions.

A first set of computer instructions will overlay binning lines 308 onto the rotated and tilted monochrome frame buffer data 222. The image processing module 300 open provide an intensity histogram 310 of the resultant data. Dependent upon user input, the image processing module 300 will then display the intensity histogram in a separate window 312, or alternatively, the intensity histogram will be displayed in a preview window 314.

A second set of computer instructions in the image processing module 300 will subtract a background 316 from the monochrome rotated and tilted frame buffer data 224. After the background has been subtracted 316, the image processing module 300 will apply instructions for vertically binning 318. Then the resultant image is horizontally binned 320.

Once the image processing module 300 has completed the second set of instructions, a signal is transmitted to the data analysis and presentation module 400 module indicating that binned pixels data 322 is available for processing.

For frames to flow throw the various processing stages, each stage is an independent object. For example, suppose you have component “A” that does some processing of the frame data. Upon completion the component generates an event that any other object can catch, and use to access the frame data. In this example, component “B” registers with component “A” so that when component “A” has data, it generates an event/callback specifically to component “B” to signal there is a data frame ready for processing.

In another embodiment, rather than the registration process above, a standard event internal operating systems event handling can be used where component “A” generates an event which Component “B” catches.

As described earlier, by specifying that a specific component should act when a global event generated by a previous component occurs, the components can signal one another sequentially in a chain when a data frame is ready. For example if a user makes changes in the Rotation component 304, the Rotation component 304 can trigger an event that regenerates the entire component chain to reprocess the original frame starting at the output of the convert image data 220. This eliminates the end user having to reply all of the processing steps one by one just because a parameter has changed in the middle of analysis.

RGB color intensity 302 converts any color input into data. The converted pixels, that are byte-sized, can be processed considerably faster than color data. The user has the option to discard color data, or to convert the color data it to monochrome data for processing. Pseudo instructions for accomplishing this are:

For Row = 0 to GetFrameHeight do

For Column = 0 to GetFrame Width do
OldPixelValue = GetFramePixel( Row, Col)
NewPixelValue = ConvertRGBValueToMono(OldPixelValue)

SetFramePixel(NewPixelValue)

data lends itself to concurrent processing, since the pixels are independent of one another, two simultaneous tasks can operate on different portions of the image. With a GPU or other multi-core processor, the processing can be split into concurrent processes.

The image data is rotated 304 using standard image rotation algorithms or using a commercial library. This process can be done concurrently using GPU or multiple cores if available. Before rotation 304, the image data is tilted 306 (widened and/or heighten) so that the image data is orthogonal. Any new columns or rows added by tilting 306 the image data are set to black. In a preferred embodiment, the image data is widened so that there is no loss of data when the image is rotated 304.

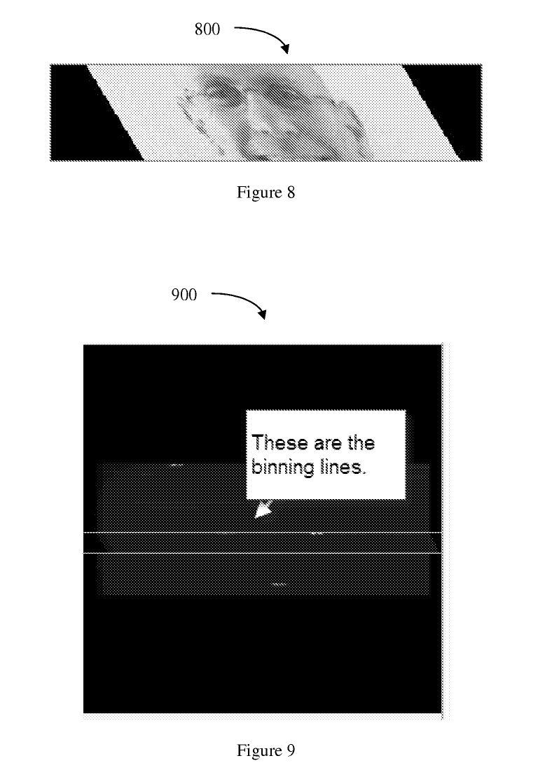

A moving object, such as, for example, a meteor or comet, or certain hardware configurations can cause the image to appear as shifted in the x-axis. FIG. 8 is an example of a shifted image in the x-axis with a severe slant.

Since the image processing module 300 will be summing (“binning”) each column of data, the image data has to be de-tilted. Below is an exemplar of a procedure to accomplish this:

Procedure FixTilt( aRowStart: Integer // de-tilt starting at this row

aRowStop: Integer // de-tilt up to this row

PixelsPerRowToDeTilt: Integer // e.g. 2 means slide pixels on

row 0 by 2, pixels on row 2 by 4
if (PixelsPerRowToDeTilt > 0) then
StartCol = GetImageWidth // moving pixels to right. Start at
rightmost col
StopCol = 0
ColStep = −1

else

StartCol = 0 // moving pixels to left Start at leftmost col
StopCol = aPixels32.Width − 1
ColStep = 1
MoveByPixels = 0
for Row = aRowStart + 1 to aRowStop − 1 do
SourceCol = StartCol
while (SourceCol <> StopCol) do
TargetCol = SourceCol + Round(MoveByPixels)
if (TargetCol >= 0) AND (TargetCol <= (ImageWidth − 1)) then
SetPixel(TargetCol, Row, GetPixel(SourceCol, Row))
Inc(SourceCol, ColStep)
MoveByPixels = MoveByPixels + SlantInPixelsPerRow

In another embodiment the image processing module 300 will actually split the flux across two pixels proportionally instead of using the function Round(MoveByPixels).

The user can select and overlay binning lines 308 (also shown in FIG. 9) by dragging a cursor over the screen image to encompass the range that the user desires to sum (“bin”) data for spectroscopic processing.

The image processing module 300 will display and overlay the binning lines 308 to the user and allow them to be dragged by user. The displayed image on the screen is scaled, since there may be thousands of pixels across present in the data making is cumbersome to show.

The scaling process removes some rows and columns (called “re-sampling”), so that, for example, a 4000×2000 pixel image is displayed on the screen in a window that is 400×200. In this example, only one in ten lines is retained. However, there exists a problem with this scaling. Simply inserting binning lines as pixel data directly into the image, those rows may not be visible since by chance they are removed by the re-sampling (scaling) process. Therefore, the image processing module 300 super-imposes on the screen the binning lines on top of the image as separate visual components (the orange lines). These can be dragged up and down by the user.

If user clicks and drags above or below the binning box, the image processing module 300 moves just one line. If the use clicks and drags between the two lines, the image processing module 300 moves both lines.

Each time the image processing module 300 receives an event from the operating system regarding line movement, call the trigger function, the image processing module 300 re-pumps the current frame through the entire processing chain. Also, the operating system mouse event hander is called each time the user drags the lines one or more pixels vertically, we get a mouse event. The following pseudo code is an exemplar of how the image processing module 300 acts on the overlaid binning lines:

Procedure UserDraggedBinningLines
begin

If Left Mouse Button is down AND mouse over image then
Move the binning range lines to current mouse position
Convert the screen coordinates of the mouse to Binning Line Percent
from Top of image for each of the two binning lines and save them as
the start and stop rows for binning in Component 318

End

Additionally, if the user resizes that the application window, the size of the displayed image changes, so the image processing module 300 has to re-position the binning lines so they're over the proper part of the image. Example code for the system is:

Window Resize Event Handler: Called each time the form size changes:
Procedure WindowResized
Begin

```
Convert Binning Line Percents from Top of image to screen
  coordinates using the image's top row in screen coordinates.
  Move binning line components to the calculated screen position.
```

End

The intensity histogram 310 performs three distinct functions: (i) computes a histogram of pixel intensities, (ii) displays the histogram, and (iii) provides a means for the user to set a range that stretches the image contrast.

Procedure ComputeHistogram
Variable Histogram: Array[0..255] of Integer
Begin

Zero Histogram array
For each pixel in image

ByteValue = Convert the pixel flux intensity to 0-255 range by

scaling using maximum pixel value

Histogram[ByteValue] = Histogram[Byte Value] + 1

End

This can be done concurrently with multiple threads.

Applying the histogram to all pixels:

Variables Row, Col Integer
Begin

Slope = Max − Min// values of slider on screen that user dragged
for Row = RowStart to RowStop do

```
  for Col = 0 to ImageWidth do
  ApplyHistogram(aBuffer, Row, Col)
end
```

Applying the histogram: (can be done concurrently as multiple tasks)

Variable OrigPixelValue: Byte // gray scale value
NewPixelValue: Byte
begin

NewPixelValue = Black
OrigPixelValue = GetPixelValueInGrayScale(Col, Row)
if (OrigPixelValue < LowerBound) then // most common (black) so
we do this first
NewPixelValue = 0
else if (OrigPixelValue > fUpperBound) then
NewPixelValue = 255
else if (fSlope <> 0) then { scale it }
NewPixelValue = Round((OrigPixelValue − LowerBound) / Slope)
if (OrigPixelValue <> NewPixelValue) then
SetPixelValue(Col, Row, NewPixelValue)

end { ApplyHistogram }

Once the histogram is applied, the image is scaled (re-sampled) and displayed in a preview window 314 so that the user can view the data in the limited viewport of the form. The components that are part of the programming language or the operating system do this scaling.

The user can zoom in on the image using a special zoom window 312. The display zoom window 312 uses conventional image scaling to show the image with binning lines. The user can zoom the image with their mouse wheel. Zooming allows the user to see clearly the individual pixels so they can position the horizontal binning lines as close to the spectrum data as possible without excluding any data to be analyzed.

By subtracting the background 316, the user can reduce camera and light pollution noise. The user can specify the number of rows to subtract, and whether that number of rows is the number above or below. The user can also select a median or mean for averaging to subtract from the background 316. Pseudo code for performing this:

Function CalculateAverageBackground( aAboveBackgroundStartRow: Integer

aAboveBackgroundStopRow: Integer
aBelowBackgroundStartRow: Integer
aBelowBackgroundStopRow: Integer
var aBackgroundPixels: TArrayOfSingle
aMean: Boolean
aPixels32: TPixels32
aSubtractAbove: Boolean
aSubtractBelow: Boolean ):boolean

var

Col: Integer
Row: Integer
NumberOfRows: Integer
ColumnValues: TList<Cardinal>

begin

Result = TRUE
ColumnValues = nil
if (NOT aMean) then // median
ColumnValues = TList<Cardinal>.Create
NumberOfRows = 0
try
if aSubtractAbove then
NumberOfRows = (aAboveBackgroundStopRow − aAboveBackgroundStartRow) +

1

if aSubtractBelow then
NumberOfRows = NumberOfRows + (aBelowBackgroundStopRow −

aBelowBackgroundStartRow) + 1

if (NumberOfRows > 0) then
begin
for Col = 0 to aPixels32.Width − 1 do (*$R−*)
begin
if aMean then
begin // Mean

if aSubtractAbove then

for Row = aAboveBackgroundStartRow to aAboveBackgroundStopRow do
aBackgroundPixels[Col] = aBackgroundPixels[Col] +

aPixels32.GetGrayScale32(Col, Row)

if aSubtractBelow then
for Row = aBelowBackgroundStartRow to aBelowBackgroundStopRow do
aBackgroundPixels[Col] = aBackgroundPixels[Col] +

aPixels32.GetGrayScale32(Col, Row)

aBackgroundPixels[Col] = aBackgroundPixels[Col] / (NumberOfRows − 0)
end // Mean
else
begin // Median
ColumnValues.Clear
if aSubtractAbove then
for Row = aAboveBackgroundStartRow to aAboveBackgroundStopRow do
ColumnValues.Add( aPixels32.GetGrayScale32(Col, Row))
if aSubtractBelow then
for Row = aBelowBackgroundStartRow to aBelowBackgroundStopRow do
ColumnValues.Add(aPixels32.GetGrayScale32(Col, Row))
ColumnValues.Sort
if Odd(NumberOfRows) then
aBackgroundPixels[Col] = ColumnValues.Items[(NumberOfRows Div 2)] //

mathematically, should have +1, but 0-based would offset it

else // even
aBackgroundPixels[Col] = (ColumnValues. Items [(NumberOfRows Div 2)−1] +
ColumnValues.Items[(NumberOfRows Div 2)]) / 2.0 // average of 2 center points
end (*$R+*)
end // for Col = 0 to aBuffer.Width − 1 do
end
except
Result = FALSE
end
if Assigned(ColumnValues) then
FreeAndNil(ColumnValues)

end { CalculateAverageBackground }

In another embodiment the user can specify a background area that is not directly adjacent to the binning box to be used for the subtraction 316.

The key step to convert a spectrum to a profile graph is to sum each column, within the rows the user has indicated that they want to bin (using the orange binning lines). This is called vertical binning 318. The value of the real-time chain of components here is that each time the user drags the orange binning lines, the entire chain of components is triggered to process the current image, so the user can see the results immediately.

Variable BinnedPixels Array[ ] of Integer
for Col = 0 to Width − 1 do
begin
for Row = RowStart + 1 to RowStop − 1 do
begin
PixelValue3 = GetPixelVlaue(Col, Row)
BinnedPixels [Col] = BinnedPixels [Col] + PixelValue32 //if
end // for Row.
end

By combining adjacent cells of the image data, by horizontal binning 320, image noise can be reduced. Here, since the data is already vertically binned 318 to the “BinnedPixels” array above, the horizontal binning 320 is very fast because there is a single one dimensional array rather than an entire image to process.

At this point, the image processing module 300 has completed processing of the image data. The binned pixels data is passed on to data analysis and presentation module 400 for processing.

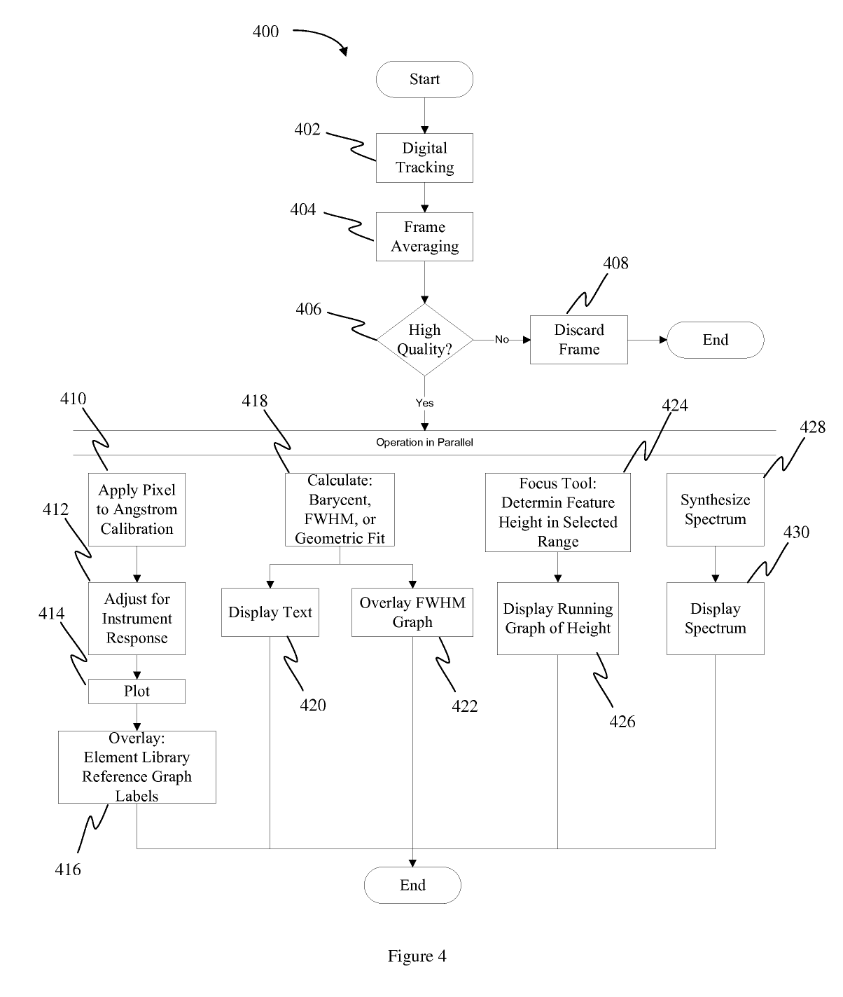

FIG. 4 is a flowchart diagram of a data analysis and presentation module 400 useful in the system of FIG. 1. The binned pixels data 322 is received by the data analysis and presentation module 400. The data analysis and presentation module 400 processes the digital tracking 402 of the binned pixels data 322. The data is then processed using frame averaging 404. If the frame average is not of a sufficient quality the frame is discarded 408. If the frame is of sufficient quality, then the binned pixels data 322 is converted to Angstroms 410. Then, the binned pixels data 322 is adjusted for instrument response 412, and then plotted 414. Finally, and overlay 416 of the processed data is displayed. The overlay comprising sections from the element library, a reference graph and labels.

Optionally, after the application pixel to angstrom calibration 410's complete, calculations 418 are performed on the data. These calculations include Barycenter, fullwidth half maximum (FWHM). The FWHM calculations can be either Gaussian and or geometric to fit the data. Then, it text display 420 of the calculations is shown to the user. Also, and overlay FWHM graph 422 is displayed to the user.

Additionally, the user can operate a focus tool 424 to determine feature height in a selected range. A display of running graph height 426 is also shown to the user.

Optionally, the data analysis and presentation module 400 can display a real-time profile graph 1100 that has been calibrated for instrument response. The profile graph 1100 can be used to determine the temperature of the observed object using a Planck curve, or identify the spectra class of the star by comparing the similarity of its curve to a library of curves of different known objects.”

Moreover, the angstrom calibration data for 10 is used to synthesize a spectrum 428, which is then drawn 430 and displayed to the user.

Digital tracking 402 is used to average multiple frames of image data (video or single images). The image data should be aligned on the exact pixels from frame to frame. Errors in telescope or other spectrographic image acquisition equipment tracking and changes in visibility can move the image in successive image frames. Digital tracking 402 re-aligns the image. The digital tracking 402 here is done on the binned pixels data 322 rather than an entire image like other prior art systems. This makes it extremely fast: exponentially so since the binned pixels data 322 data is a single dimensional vector array rather than a 2D image.

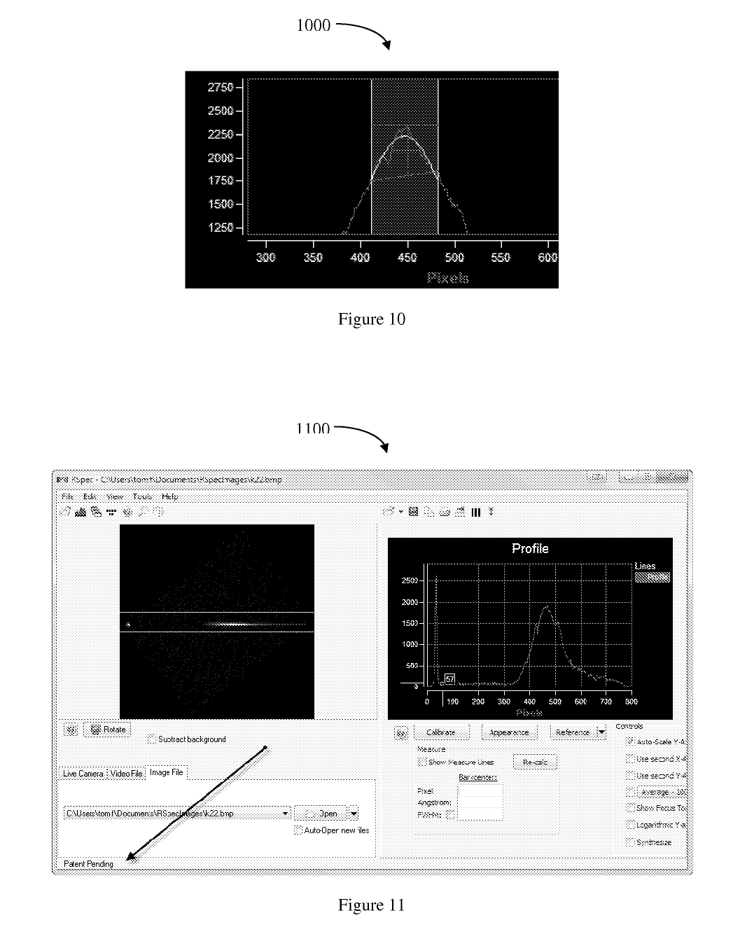

The user selects a feature (peak or trough) on the profile graph 510 using the vertical “measure lines” 508. By selecting the left most and rightmost x-value that encompasses the feature that the user desires to analyze. The data analysis and presentation module 400 calculates the “center” of that feature, using either Barycenter or Guassian curve fitting (also shown in FIG. 10). As subsequent binned pixels data 322 frames arrives, the data analysis and presentation module 400 determines the “center” in the same x-range and if it differs, moves the pixel data left or right in the array.

Procedure MarkRange - called when user selects the range of the feature to use when
tracking

LeftTrackX = VerticalMeasureLineLeft
RightTracakX= VerticalMeasureLineRight
If tracking with Barycenter then
FeatureCenter = CalculateBarycenterbetweenTwoPoints(LeftTrackX, RightTrackX )
Else if tracking with Gaussian then
FeatureCenter = CalculateGaussianBetweenTwoPoints(LeftTrackX, RightTrackX )
Else . . . add additional center calculation methods here.

Procedure AlignCurrentFrameWithPreviousCenter - called on each subsequent frame

CurrentCenter = CalculateBaryCenterBetweenTwoPoints(LeftTrackX, RightTracX)
If CurrentCenter <> FeatureCenter then// need to shift array left of right
ShiftArray( FeatureCenter − CurrentCenter)

Procedure ShiftArray( Delta: Integer)

For Col = 1 to Width
BinnedPixelArray[Col] = BinnedPixelArray[Col + Round(Delta)]

Alternatively, for more precision, non-integer data is used by removing e the Round( ) function above and determine what proportion of the flux data from each cell get apportioned to adjacent cells.

To further reduce noise and increase signal, a frame averaging/stacking is performed by the data analysis and presentation module 400. The user indicates the number of frames to be averaged, “stack depth” (“depth”). Frame stacking 404 is done using the BinnedDataSum[ ] array rather than image, making it exponentially faster because it's a 1D rather than 2D array. In one embodiment, a list of all of the contents of all previous frames is kept (up to the depth being averaged) and calculate an average across all of these each time a new frame arrives. This approach is computationally expensive and less efficient. In a preferred embodiment to increase efficiency, the data analysis and presentation module 400 will keep the sum of the depth frames, and also the oldest frame. Then, when a new frame arrives, the data analysis and presentation module 400 subtracts the oldest, adds the newest, and takes the average by dividing by the depth frames. The following example assumes that the data analysis and presentation module 400 is instructed to stack the last ten frames in a video and that the current frame is number 15:

BinnedDataSumAllFrames[ ] is the sum of BinnedData for frames 6
through 15.
OldestBinnedDataSum[ ] is frame 6.
When frame 16 arrives:

BinnedDataSumAllFrames = FramesSum − OldestBinnedData +

BinnedData // vector math

BinnedData = BinnedDataSumAllFrames/10 // ten is the user-
selected stack depth.

No matter how deep a stack the user requests, after the first depth frames are processed, the time to execute the above code is the same.

The user can optionally set quality criteria 406 to filter out and image frames from being stacked that fall below the quality criteria 406. The filter uses the same calculations for FWHM 418 or Focus tool 424 to display a graph of image quality for each frame that arrives (also shown in FIG. 10). If the results of the FWHM 418 or Focus tool 424 calculations are below the user defined criteria, the frame is discarded 408.

Additionally, the data analysis and presentation module 400 can export all the frames from of a video into .BMP files that can be loaded into a list on the screen. The user can select any of the images in the list, and the data analysis and presentation module 400 immediately loads and displays the image. The user can visually examine the profile graph, and add or remove a checkmark to the filename in the list to accept or discard the file. Then a video file is created from the list.

A pixel-to-angstrom calibration 410, is then applied to the image data by the data analysis and presentation module 400. The binned pixel data 322 up until this point has been a 1D array of flux, indexed by pixel number. In other words, BinnedData[15] is the binned pixels data value in column 15 of the source image. The data analysis and presentation module 400 first converts this data to an array of objects/records that have two 2 elements: flux value (y) and pixel value (x) as shown below:

Step 1: Convert to 2D array, using pixel number as second index)

For Element = 0 to Width
BinnedDataCalibrated[Element].X = BinnedData[Element]
BinnedDataCalibrated[Element].Y = Element

Step 2: convert the Y elements to Angstroms

For Element = 0 to Width
BinnedDataCalibrated[Element].X =

ConvertPixelToAngstrom(BinnedDataCalibrated[Element].X)
Function ConvertPixelToAngstrom(Pixel) returns Float

Apply user specified conversion factors (linear y=mx+b, OR

polynomial factors to solve for y (Angstroms) from X Pixels)

The plot display 414 on the right side of the screen 500 is done asynchronously and can be done by any commercial plot component.

If the user has selected to apply a real-time flux calibration to adjust for instrument response 412 to the graphed data, the following factors are applied to the plot data:

Procedure ApplyInstrumentResponse
For row = 0 to Width
BinnedDataCalibrated[Row].Y = BinnedDataCalibrated[Row].Y/
GetFluxCalibrationForAngstromValue(BinnedDataCalibrated[Row].X)

Function GetFluxCalibrationForAngstromValue( AngstromValue)
‘ The flux calibration array is in Angstroms, but may be different
Angstrom values
‘ eg. FluxCal[1].X may be 5000 Angstroms (where FluxCal.Y is
the factor)

Interpolate in FluxCal array, finding the...

The data is then plotted 414:

Procedure PlotData
For Row = 0 to Width
Graph(BinnedDataCalibrated[Row].X, BinnedDataCalibrated[Row].X)

The plot 414 component can optionally auto-scale the display all points (if user has selected that), and will maintain a zoomed level if selected by user.

If the user has selected an element library or reference graph to display 416, a second plot of vertical lines are displayed on the graph. These are in a different color and are can be changed by the user without affecting the original plot data.

At this point the data analysis and presentation module 400 has fully processed and is displayed the data in this parallel chain. The following steps extract auxiliary statistics from the frames in real-time.

The CalibratedBinnedData vector elements that are in the range that is bracketed by the user by vertical cursor lines 504 and 506 can be used to extract and display statistics of the data. A calculation of the Barycenter, FWHM or geometric fit of the data 418 is performed by the data analysis and presentation module 400. The Barycenter calculation shows the “center of mass” of the data.

And example of a Full Width Half Maximum (FWHM) calculation 418 is shown below:
1. Determine if the points in the range are inflected up or down. (e.g. do a Gaussian fit and use results)
2. Assuming inflected up: Find the max point on the curve.
3. Calculate equation of horizontal line through max point between the two cursors
4. Calculate equation of vertical line from max to base.
5. Calculate midpoint on vertical line.
6. Calculate equation of FWHM line.

If inflected down, perform the same calculations as above, but using minimum point in step 2 and 3 and 4.

If calculating FWHM using Gaussian, perform a Gaussian fit of line and then take the FWHM from the result.

If the user selected to see a graph of the results of the calculations 418, then the FWHM graph is overlaid 422 on the display 500.

A display text 420 of the numeric results of the calculations of Barycenter or FWHM can also be shown on the display 500. The data analysis and presentation module 400 updates the on-screen grid with these numeric values.

The focus tool 424 displays a running graph indicating the quality of the image. The focus tool 424 determines the quality using one of two methods:
1. FeatureQuality=FWHM on a feature, using the same calculations of C7.
2. Determining the height (or depth) of a feature on the graph, as bracketed by vertical cursor lines.

Variable SearchForMinimium (Boolean) = user indicated minimum feature is to be
measured
Variable SearchToLeft (Boolean) = user selected to search to the left from the minimum
or maximum as indicated by SearchForMinimum
Variable Infection.X and Inflection1.Y - x,y coordinates of inflection
Variable endPoint.X and endPoint.Y - x,y coordinates of other end of feature
If SearchForMinimum then

Inflection = FindMinimumInRange - returns x and y value of minimum Y value in range

Else

Inflection = FindMaximiumXInRange - returns x and y value of maximum Y value in

range
‘ Set the x values and direction over which to search
if SearchToLeft then

StartingSearchX = Left Cursor X Value
StopSearchX = Inflection.X

Else

StartingSearchX = Infection.X
StopSearchX = Right Cursor X value

‘ Find the other “end” of the feature
If SearchForMinimum then

EndPoint = FindMaximumYInRange(StartingSearchX, StopSearchX)

Else

EndPoint = FindMinimumYInRange(StartingSearchX, StopSearchX)

FeatureQuality = Absolute Value (EndPoint.X − Infection.X) // height of feature

Using the FeatureQuality from the focus tool 424, a running graph of height 426 values can be displayed. The user can examine the focus tool 424 as the user changes the focus of the camera to adjust for maximum height.

A real-time synthesized spectrum 428 can be display in monochrome or color. The window in which the synthesized spectrum 428 is displayed is stretched horizontally to be the same width as the x-axis on the graph. The synthesized spectrum 428 shows only the visible range of x-axis values from the profile graph. The synthesized spectrum 428 (like all components) is a separate process and updates the screen in real-time as each frame event propagates through the system 100. Pseudo code for the synthesized spectrum 428 is shown below:

For each column of the synthesized spectrum window
Get The Color And Its Intensity From The Profile
Draw the color in this column of the synthesized spectrum window.
// These two constants are used to map (stretch) from the column number in the Syn.
Spectrum window to
// the wavelength (x-axis) value from the profile that we are plotting.
HorizontalStretchM = XAxisProfileGraph.MaxX − XaxisProfileGraph.MinX // M in
y=mx+b
HorizontalStretchB = XaxisProfileGraph.MinX // B in y=mx+b
// These two constants are used to map (stretch) the intensity values on the Syn.
Spectrum window to the
// range of intensities that we can display on the screen
GetIntensityScalingFactors (IntensityScalingM, IntensityScalingB) // M and B in
y=mx+b
For SynthesizedImagePixelNumber = 1 to SynthesizedImageWidth do

ProfileValueToPlot = (HorizontalStretchM * SynthesizedImagePixelNumber) +

HorizontalStretchB // Angstroms or pixels

FluxIntensity = GetYValueFromProfileForX(ProfileValueToPlot)
if Color then // user selected to see a color synthesized spectrum.
PixelIntensityColor = (FluxIntensity * IntensityScalingM) + IntensityScalingB
PixelColor = CalculateColor(Round(ProfileValueToPlot), PixelIntensityColor)
for Row = 0 to HeightOfSynthesizedSpectrumWindow do // draw all pixels in this

column in syn. spectrum

SetPixel[ImagePixelNumber, Row] = PixelColor
Else // Black and white
PixelIntensityBlackAndWhite = Trunc((FluxIntensity * IntensityScalingM) +

IntensityScalingB)

PixelIntensityBlackAndWhite = Max(PixelIntensityBlackAndWhite, 0)
PixelIntensityBlackAndWhite = Min(PixelIntensityBlackAndWhite, 255)
for Row = 0 to OutBuffer.Height − 1 do // draw all pixels in this column in syn.

spectrum

SetPixel(ImagePixelNumber, Row, PixelIntensityBlackAndWhite)
constants
LOWEST_VISIBLE_WAVELENGTH = 3800

HIGHEST_VISIBLE_WAVELENGTH = 7800

GAMMA =1.6

// Given a Wavelength and FluxIntensity, returns the color value to display on the

screen

Function CalculateColor(WaveLength: Integer FluxIntensity: Double): Color
var
Red, Green, Blue: Integer
Hue, Sat, Intens: Double
begin
if (aWaveLength < LOWEST_VISIBLE_WAVELENGTH) OR (aWaveLength >

HIGHEST_VISIBLE_WAVELENGTH) then

Result = clBlack
else
Result = WaveLengthToColor(aWaveLength div 10, GAMMA) // to OS color value

from Angstroms

Red = Result and $FF
Green = (Result and $FF00) shr 8
Blue = (Result and $FF0000) shr 16
//Convert to HSI so we can change the intensity value we can set to FluxIntensity
RGBtoHSI(Red, Green, Blue, Hue, Sat, Intens)
FluxIntensity= aADU
HSItoRGB(Hue, Sat, Intens, Red, Green, Blue)
Result = RGB(Red, Green, Blue)
end // CalculateColor

// Returns two constants used to map (stretch) the intensity values on the Syn. Spectrum
window to the
// range of intensities that we can display on the screen

function.GetIntensityScalingFactors( aIntensityScalingM: Double
IntensityScalingB: Double)
constants
MAX_COLOR_VALUE = 1 // GetColor's call HSItoRGB must have HSI Intensity

range of 0..1

MAX_BW_VALUE = 255 // SetGrayScale takes values 0..255
GetProfilesMinMax(aYPoints, MinimumProfileIntensity, MaximumProfileIntensity)
Run = (MaximumProfileIntensity − MinimumProfileIntensity)
if UserWantsColorSynthesizedSpectrum then
aIntensityScalingM = MAX_COLOR_VALUE/Run // M = Rise/Run
else
aIntensityScalingM = MAX_BW_VALUE/Run
// y = mx + b --> b = y − mx We'll use y of 0, so b = −mx
aIntensityScalingB = − aIntensityScalingM * MinimumProfileIntensity

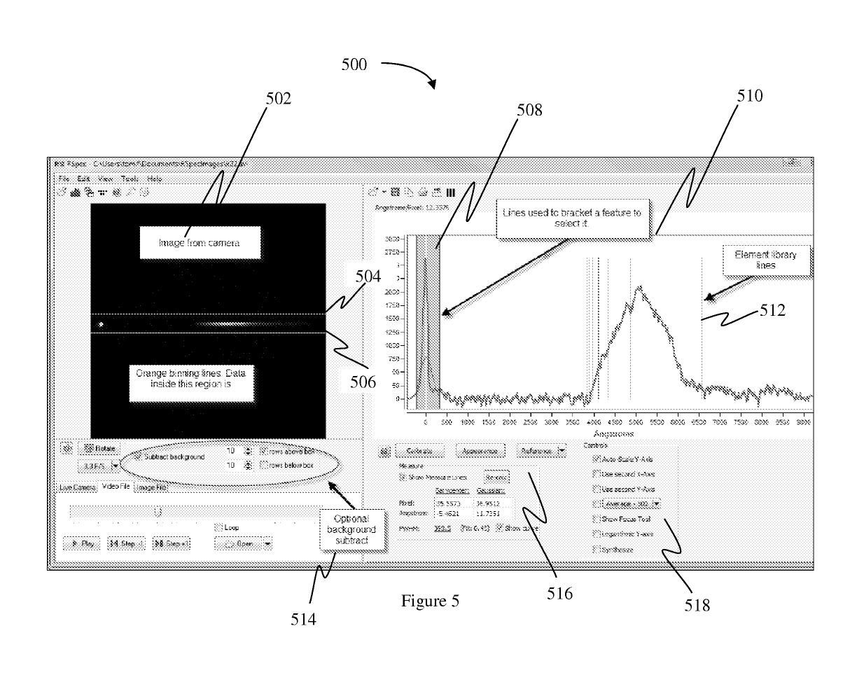

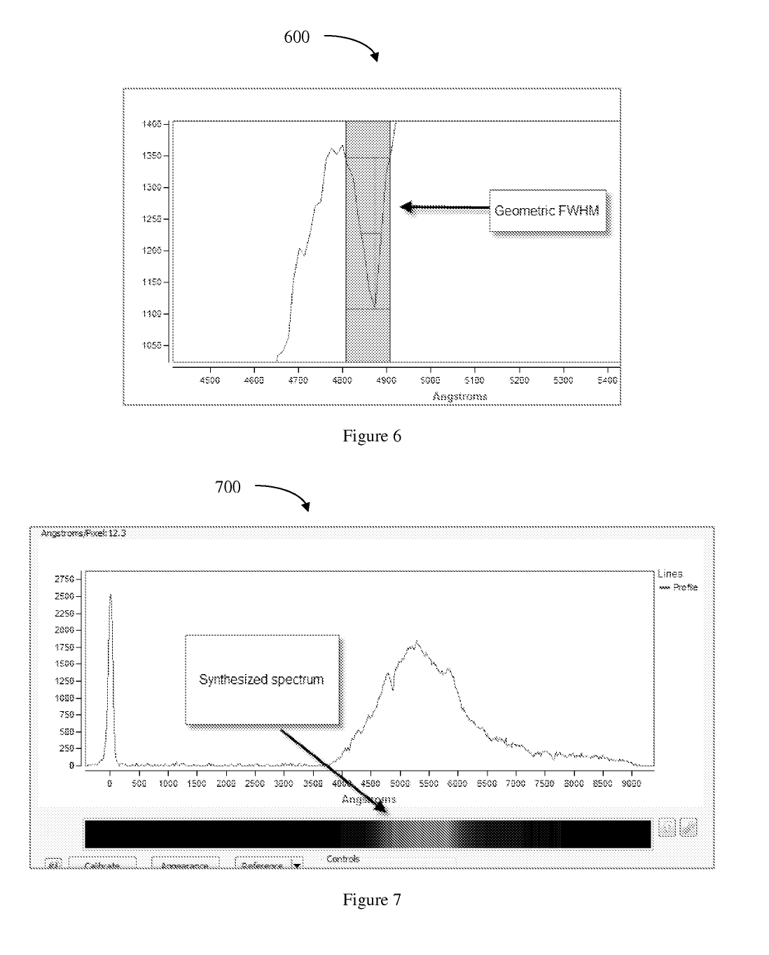

FIG. 5 is a screenshot 500 of a real time spectroscopy processing and analysis system that is simple, integrated and efficient according to one embodiment. As can be seen in this embodiment, an image from the camera 502 is displayed to the user. To binning lines 504 and 506, are used to isolate the data contained in the image. The user can also select and bracket a particular feature 508 of the profile graph 510 and perform real-time analysis on only the selected feature. Element lines 512 are also displayed on the profile graph 510 to indicate known elements from the library. The user can optionally adjust the image 502 using controls 512 subtract a background from the image to reduce noise and increase the acquired signal. Other real-time user controls 516 and 518 provide the user with other real-time controls that can be used to adjust the data displayed.

Referring now to FIG. 11, there is shown a screenshot of a graphical user interface according to one embodiment of the invention. As can be seen the image, and all the calculations and controls are displayed in real time to the user. Any adjustments to the controls are reflected in the plot and graphs of the data in real time.

What has been described is a new and improved real time spectroscopy processing and analysis system that is simple, integrated and efficient, overcoming the limitations and disadvantages inherent in the related art. The advantages of this real-time spectroscopic analysis system and its intended advantages over the prior art are clearly superior to currently available options. By having a single system incorporating multiple facets of separate systems and including new systems, the user has instant results from the data acquired and the ability to manipulate that data and transform it into meaningful results.

Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

What is claimed is:

1. A real time spectroscopy processing and analysis system comprising computer instructions for:
a) a data acquisition module;
b) an image processing module operably connected to the acquisition module; and
c) a data analysis and presentation module operably connected to both the data acquisition module and the image processing module.

2. The system of claim 1, where the data acquisition module comprises instructions to acquire and convert a plurality of image and video formats into a single data format.

3. The system of claim 2, where the data acquisition module comprises instructions for a processor operable to acquire and convert a FITS file image.

4. The system of claim 2, where the data acquisition module comprises instructions for converting conventional images, video recordings, and live video into the single data format.

5. The system of claim 2, where the conventional images can be selected from the group consisting of TPG, BMP, TIF and DSLR raw.

6. The system of claim 4, where the data acquisition module can optionally comprise instructions to automatically enter and convert the conventional images, video recordings and live video to the single data format by monitoring a specific file location or one or more file folders.

7. The system of claim 4, where the live video data can optionally be tracked using a log file.

8. The system of claim 4, where the live video data is reduced in size by dropping frames.

9. The system of claim 4, where the live video data is cropped prior to being converted.

10. The system of claim 1, where the images can be manually cut-and-pasted for processing.

11. The system of claim 1, where the data acquisition model converts the images to two dimensional (2D), intensity frame buffer data.

12. The system of claim 1, where the data acquisition module transmits a notification trigger to the image processing module and the data analysis and presentation module when the conversion is complete.

13. The system of claim 1, where the image processing module receives frame buffer data from the data acquisition model.

14. The system of claim 1, where the image processing module comprises instructions for the processor to change RGB color intensity of the frame buffer data into monochrome intensities from the received frame buffer data.

15. The system of claim 1, where the image processing module comprises instructions to rotate the monochrome frame buffer data.

16. The system of claim 1, where the image processing module comprises instructions to tilt the rotated monochrome frame buffer data.

17. The system of claim 16, where the image processing module further comprises a first set of computer instructions to overlay binning lines onto the rotated and tilted monochrome frame buffer data.

18. The system of claim 17, where the image processing module comprises instructions to display an intensity histogram of the data.

19. The system of claim 18, where the image processing module comprises instructions to apply the intensity histogram settings to an image zoom window

20. The system of claim 18, where the image processing module comprises instruction to apply the intensity histogram in an image preview window.

21. The system of claim 16, where the image processing module comprises a second set of computer instructions to subtract a background from the monochrome rotated and tilted frame buffer data.

22. The system of claim 21, where the image processing module further comprises instructions for vertically binning the image.

23. The system of claim 22, where the image processing module further comprises instructions for horizontally binning the image.

24. The system of claim 1, where the image processing module transmits a notification signal to the data analysis and presentation module indicating that binned pixels data is available for processing.

25. The system of claim 1, where the binned pixels data is received by the data analysis and presentation module.

26. The system of claim 25, where the data analysis and presentation module comprises instructions to processes the digital tracking of the binned data.

27. The system of claim 26, where the data processing used is a frame averaging.

28. The system of claim 27, where a determination of the quality of the frame is calculated

29. The system of claim 28, where the frame is discarded if the calculated quality falls below a threshold.

30. The system of claim 28, where a pixel is converted to angstroms using calibration factors provided by a user.

31. The system of claim 30, where the factors provided by the user are selected from the group consisting of linear, non-linear and polynomial.

32. The system of claim 25, where the binned pixels data is adjusted for instrument response and plotted.

33. The system of claim 25, where an overlay of the processed data is displayed wherein the overlay comprises sections from the element library, a reference graph and labels.

34. The system of claim 30, where a Barycenter calculation, a full width half maximum calculation or both a Barycenter and a full width half maximum calculation is performed on the binned data.

35. The system of claim 34, where the full width half maximum calculations can be a Gaussian calculation.

36. The system of claim 34, where the full width half maximum calculations can be a geometric calculation.

37. The system of claim 34, where a text of the calculation results is displayed to the user.

38. The system of claim 34, where a graphical overlay of the full width half maximum plot is displayed.

39. The system of claim 34, where a running graph of focus quality determined by a calculated full width half maximum value, a feature depth or both a calculated full width half maximum value and a feature depth is also displayed.

40. The system of claim 34, where the angstrom calibration data synthesized into a color spectrum and displayed.

41. The system of claim 34, where the angstrom calibration data synthesized into a monochrome spectrum and displayed.

42. The system of claim 1, where the image from the camera is displayed.

43. The system of claim 1, where the binning lines are displayed to isolate the data contained in the image.

44. A method for real time spectroscopy processing and analysis the method comprising computer instructions for:
a) acquiring image data;
b) processing the image data;
c) analyzing the image data analysis; and
d) presenting the image data.

45. The method of claim 44, where acquiring the data further comprises the step of acquiring and converting a plurality of image and video formats into a single data format.

46. The method of claim 45, where acquiring the data further comprises the step of converting conventional images, video recordings, and live video into the single data format.

47. The method of claim 46, further comprising the step of automatically acquiring and converting data by monitoring a specific file location or one or more file folders.

48. The method of claim 47, further comprising the step of reducing the live video data in size by dropping frames.

49. The method of claim 47, further comprising the step of cropping the live video data prior to being converted.

50. The method of claim 44, further comprising the step of converting the image data to a two dimensional intensity frame buffer.

51. The method of claim 44, further comprising the step of converting RGB color intensities of the frame buffer data into monochrome intensities.

52. The method of claim 51, further comprising the step of rotating the monochrome frame buffer data.

53. The method of claim 52, further comprising the step of tilting the monochrome frame buffer data.

54. The method of claim 53, further comprising the step of overlaying binning lines onto the rotated and tilted monochrome frame buffer data.

55. The method of claim 54, further comprising the step of displaying an intensity histogram of the data.

56. The method of claim 54, further comprising the step of applying the intensity histogram in a zoom window.

57. The method of claim 54, further comprising the step of applying the intensity histogram in a preview window.

58. The method of claim 53, further comprising the step of subtracting a background from the monochrome rotated and tilted frame buffer data.

59. The method of claim 58, further comprising the step of vertically binning the image.

60. The method of claim 58, further comprising the step of horizontally binning the image.

61. The method of claim 54, further comprising the step of processing the data using a frame averaging.

62. The method of claim 61, further comprising the step of calculating a quality of the frame average.

63. The method of claim 62, further comprising the step of discarding the frame if the calculated quality falls below a threshold.

64. The method of claim 63, further comprising the step of applying a pixel is converted to angstroms using calibration factors provided by the user.

65. The system of claim 64, where the factors provided by the user are selected from the group consisting of linear, non-linear and polynomial.

66. The method of claim 63, further comprising the step of calculating and plotting an adjustment for instrument response of the binned data.

67. The method of claim 63, further comprising the step of overlaying and displaying the processed data wherein the overlay comprises sections from the element library, a reference graph and one or more than one label.

68. The method of claim 62, further comprising the step of calculating a Barycenter, a full width half maximum or both a Barycenter and a full width half maximum calculation on the binned data; wherein the full width half maximum calculations can be a Gaussian calculation a geometric calculation or both a Gaussian and a geometric calculation.

69. The method of claim 68, further comprising the step of displaying a text of the calculations results is displayed to the user.

70. The method of claim 66, further comprising the step of displaying a graphical overlay of the full width half maximum plot.

71. The method of claim 66, further comprising the step of displaying a running graph of focus quality determined by a calculated full width half maximum value, a feature depth or both a calculated full width half maximum value and a feature depth is also displayed.

72. The system of claim 71, where the angstrom calibration data synthesized into a color spectrum and displayed.

73. The system of claim 71, where the angstrom calibration data synthesized into a monochrome spectrum and displayed.

74. The method of claim 1, further comprising the step of displaying the image from the camera.

75. The method of claim 1, further comprising the step of displaying binning lines to isolate the data contained in the image.
